(19) United States
(12) Patent Application Publication
(10) Pub. No.: US 2008/0022263 A1
(43) Pub. Date: Jan. 24, 2008

(54) Identifying The Origin Of Application Resources

(76) Inventors: Nathan V. Bak, Portland, OR (US); Claudia S. Mueller Thomson, Stow, MA (US)

Correspondence Address: LIEBERMAN & BRANDSDORFER, LLC, 802 STILL CREEK LANE, GAITHERSBURG, MD, 20878, US

(21) Appl. No.: 11/459,578

(22) Filed: Jul. 24, 2006

(51) Int. Cl. G06F 9/45

(52) U.S. Cl. 717/136; 717/174

(57) ABSTRACT

A tool is provided for translation verification testing of various forms of translatable objects in an installed application. The tool attaches tags to a select set of translatable objects. In general, the tags attached to the translatable objects identify the source of the tag. This enables the component of the tag to be verified in a non-complex manner. In one embodiment, a set of rules are selected and followed to predetermine attaching of tags to translatable objects in the application.

### BACKGROUND OF THE INVENTION

1. Technical Field

This invention relates to identifying the source of translatable strings in a multi-component application. More specifically, a set of rules are followed to assign tags to translatable strings wherein the tags are associated with a specific component.

2. Description of the Prior Art

When translating a literary work, such as a novel, the context for creating an accurate translation is derived from the work and the translator's understanding of the work's setting. For example, history, culture, location, and socioeconomic data are important contextual details that must be understood when translating a novel. Context is an all-important aspect for understanding the work to be translated, and the basis from which an accurate translation arises, assuming the translator has the appropriate background and expertise.

Translation of software products is more difficult than conventional works. It is compounded by a number of factors including timing for when to perform translation of user interface strings and when to perform verification testing on the translations. For example, a tool that identifies translation issues during development may function on a different principle than a tool that identifies a translation issue subsequent to development. U.S. Patent Publication No. 2004/0148591 to Kumhyr et al. is an example product and method that addresses the issue of translation of strings. More specifically, the '591 publication resolves the translation of strings during the development stage as opposed to a product and method that resolves translation of strings on an installed product, i.e. following development. A tool, such as the one described in the '591 publication, that interrupts software development for translation verification will naturally affect programming efficiency and economics of software development. Accordingly, there is a need for a translation verification tool that functions efficiently on an application subsequent to completion of application development.

A resource is a translatable element of a software application, such as a string or image, which is stored in a file separate from the main application code. When performing translation verification testing, it is often difficult for testers to determine the origin of user interface resource strings, such as menu items, button text, strings displayed in dialog boxes, and error messages. In order to efficiently correct translation errors, the origin of the strings needs to be identified. Current solutions for identifying the origin of strings include executing the program that generates the string. However, this solution is time-consuming and expensive as it requires execution of the program by a skilled software developer.

Accordingly, there is a need for a tool that allows the following: to view the user interface strings in context so they can be accurately translated, efficient and economical translation verification of an application subsequent to completion of the development process, and identification of the origin of a user interface resource string to ensure efficient correction of translation errors

### SUMMARY OF THE INVENTION

This invention comprises a method and tool for verifying translation of strings in an application while identifying the source of the string.

In one aspect of the invention, a method is provided for identifying a resource origin within an application. Initially, a tag tool is run on an install directory of a component of an installed application. A resource file for the component of the installed application is modified by adding a tag to each translatable object. In one embodiment, the tag is descriptive of a source component. The origin of the translatable object is identified based upon the tag.

In another aspect of the invention, a computer system is provided with a tag tool in communication with an install directory of an installed application, and a tag tool manager in communication with the tag tool and the installed application. The installed application includes a resource file that is modifiable by the manager. A tag is attached to each translatable object to identify the object. The tag is descriptive of a source component and identifies the origin of the translatable object based upon a characteristic of the tag.

In yet another aspect of the invention, an article is provided with a computer-readable medium. Instructions in the medium are provided for identifying the resource origin within an application. These instructions include a further set of instructions for running a tag tool on a portion of an install directory of an installed application, and instructions for modifying a resource file of the installed application by adding a tag to each translatable object. The tag is descriptive of a source component, and provides instructions for identifying the origin of the translatable object.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a flow chart of an overview of the translation verification process.

FIG. 2 is a flow chart illustrating the translation verification process according to the preferred embodiment of this invention, and is suggested for printing on the first page of the issued patent.

FIG. 3 is a block diagram of the computer system configured to employ the translation verification tool.

### DESCRIPTION OF THE PREFERRED EMBODIMENT

### Overview

A tool is provided to support translation of resource strings on an installed product, i.e. subsequent to development of the product, wherein a resource string is text that is displayed to the user and translated in association with execution of an installed product. Resource strings may be identified before or after translation of the installed product, as prescribed by a selection of rules associated with assignment of tags to identified resources. In one embodiment, a resource string and a string are synonymous, and are hereinafter referred to as translatable objects or objects. The tool supports modifying objects in a file designated for translation. The designated translatable objects may be in the form of text or images. A set of rules are followed to attach tags to select translatable objects. Each tag or set of tags are associated with a source and identify the source of the translated or translatable object. Following assignment of the tags to identified objects, a user may test the designated file(s) for translation accuracy. Testing of the file displays the identified objects with the tags attached, wherein the tags indicate the origin of the identified object. Accordingly, in the event of an error associated with translation of the object, the source of the translatable object is ascertainable through identification of the attached tag.

### Technical Details

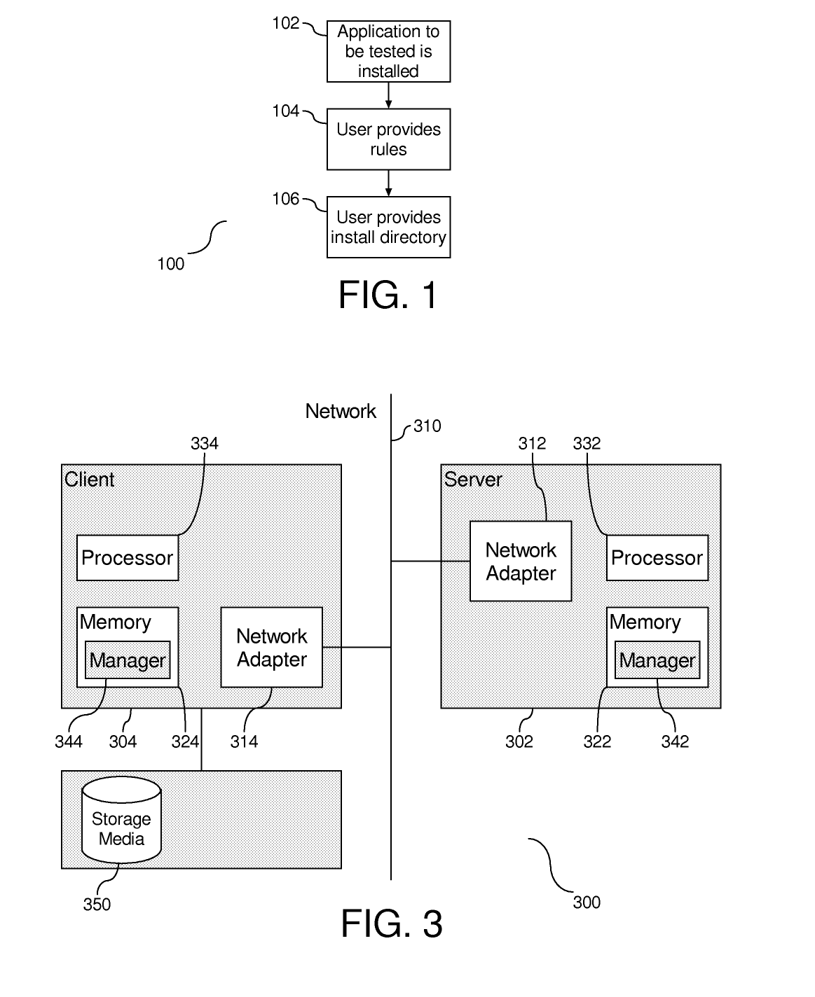

FIG. 1 is a flow chart (100) illustrating an overview of the translation verification process. Initially, an application selected for translation verification is installed in a client machine, or at another computing device in communication with a client machine (102). In one embodiment, the client machine may be in the form of a personal computer, a computer in communication with a local area network, or a computer in communication with a wide area network. A user of the application designates a set of rules for the verification tool (104) and an install directory for the application (106). The rules define the terms under which the tool identifies and potentially modifies translatable objects in the application designated for translation verification. In one embodiment, there may be different sets of rules that may be invoked by a user of the tool. For example, in one embodiment the tool may provide a list of compiled rules from which the user may select an appropriate set. Similarly, in one embodiment, the user may create a custom set of rules to be invoked by the tool. Accordingly, the initial steps in the verification process include installation of an application to be tested, and selection or creation of a set of rules to be invoked by the verification tool during the verification process.

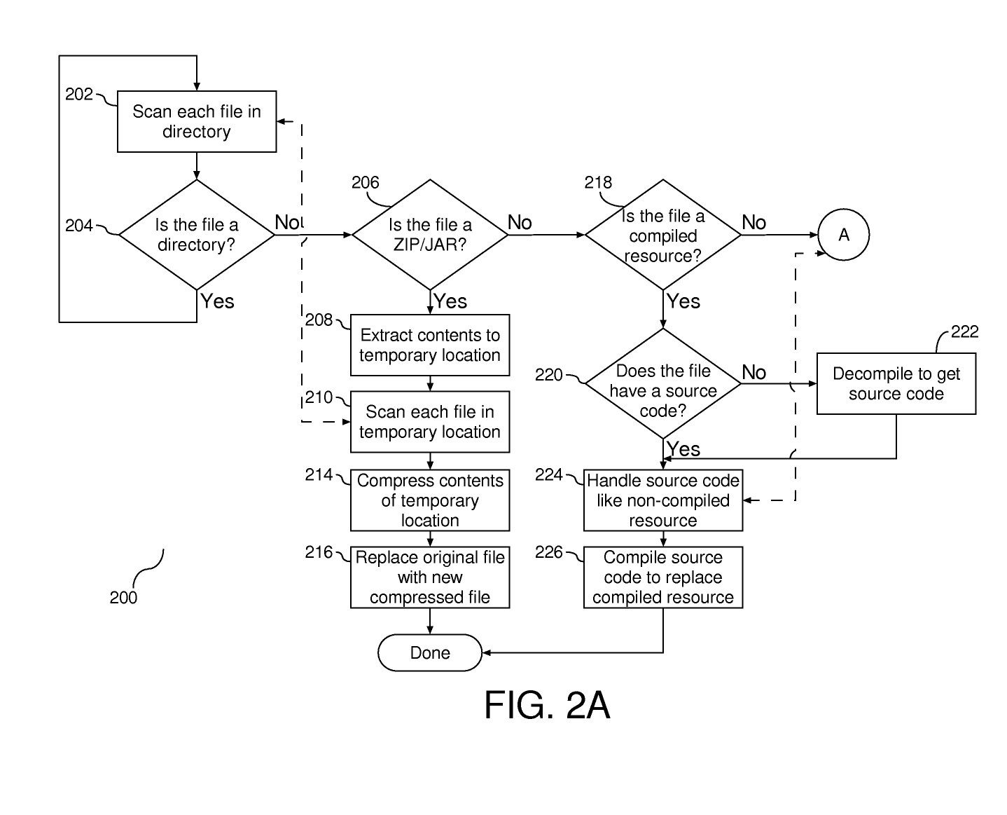

Following step (106), the user-designated rules of the verification tool are executed to initiate verification of translatable objects on the installed application. The verification process entails attaching tags to designated translatable objects in a select directory. FIG. 2 is a flow chart (200) illustrating the process that the tool follows to modify objects designated for modification by the select rules. As noted in FIG. 1, the application being tested is installed on a client machine. Each file in the install directory of the application is scanned to determine the file type (202). In one embodiment, the file type is a category of the file based on system information, such as the file extension, or another system parameter. For each file scanned, it is determine if the file is a directory other than the install directory (204). If the response in step (204) indicates the file is a non-install directory, the verification process continues using the directory ascertained at step (204) in place of the install directory of the application being scanned, and the process returns to step (202) to scan each file in the non-install directory. In one embodiment, the tool may be configured to look for translatable objects in files of the installed application. If the response in step 204 is negative, it is determined if the file in the directory being scanned is a compressed and/or archived file (206). In one embodiment, a compressed or archived file may be in the form of a zip or JAR file. Similar to a positive response in step (204), the compressed and/or archived files must be parsed so that the verification tool may scan the individual files.

If the response in step (206) is positive, the contents of the compressed and/or archived file are extracted to a temporary location (208). The following steps for the compressed and/or archived file are performed using the temporary location designated at step (208) in place of the install directory or another directory ascertained at step (204). Each file in the temporary location is scanned (210) and each file from the temporary location is processed starting at step (202) to identify translatable objects in the file(s) that had been previously compressed. Following completion of the assignment of tags to translatable object(s), as explained in detail at steps (228)-(240), the instructions return to step (214) wherein the contents from the temporary location are compressed and/or archived into a file (214). Thereafter, the original file is replaced with the new compressed file (216).

Following a negative response in step (206), it is determined if the file being tested is a compiled resource with the source code provided (218). A positive response in step (218) will result in a subsequent determination of whether the compiled resource file has source code (220). If the file has compiled source code, the resource file is decompiled to obtain the source code file(s) (222). Following step (222) or in case of a positive response in step (220), the source code file is handled like a non-compiled file (224), as described below in more detail beginning at step (228). As described below at steps (228)-(240) the non-compiled resource is parsed and appropriate tags are added to translatable objects. Following the completion of step (234) for instructions that originated at step (224), the process returns to step (226) so that the source code file(s) is then compiled to replace the original compiled resource file and the source file is deleted (226), thereby producing a new compiled file which replaces the original one. Accordingly, each compiled resource file is decompiled so that the files may be scanned to determine the source of the file for verification testing.

Following a negative response in step (218), or as noted above, following step (224), it is determined if the file is a non-compiled resource (228). A positive response in step (228) will result in a parsing of the file being tested to identify each translatable object (230). A set of prescribed rules are used to add and or attach a tag to each translatable object (232) that is identified at step (230). A tag is also known as an identifier which may be in the form of a string or symbol that is attached to an identified object, wherein the string or symbol is different than the identified object and denotes the origin of the identified object that has been or will be subject to translation. Attachment or addition of a tag to an object is to associated a unique identifying string with the object that clearly delineates the object from the tag. Different rules may include how to attach a tag to an identified object, and this would affect how a user of the tool may identify attachment of tags to identified objects. As shown at step (104), a user of the tool provides a set of rules for attachment of tags to identified objects. For example, in one embodiment, there may be a selection of rules available and these rules are presented to the user through an interface. The user would then select one or more rules from the interface selection. Rules can be set to attach tags before or after translation of the resource strings. In one embodiment, the interface may provide a custom rule process that enables the user to uniquely define the attachment of the tag(s) to identified objects. In one embodiment, the tag may be pre-attached or post-attached to the identified translatable object(s). If a specific tag is generated and attached to an identified translatable object, the tag and object information are added to an index file (234). In one embodiment, the index file is only generated with respect to generation of specific tags so that the unique tags may be properly identified. Accordingly, based upon a set of prescribed rules, tags are added to each identified translatable object and at the same time are collated into an index.

However, if the response in step (228) is negative, it is further determined whether the file in question is an image resource file (236). A positive response in step (236) will result in generating tags for the file based upon a set of prescribed rules (238). A rendering of the tag is added to one or more image files as designated by the rules (240). The tag for the image and the image file name are added to the index file. In one embodiment, not all the information may be included in the index file, such as information that is extraneous to the prescribed rules. Accordingly, based upon a set of prescribed rules, tags are added to each image.

FIG. 2 as described above outlines the process for assigning tags to translatable objects identified in non-compiled resource files and image files. The translation verification process outlined above allows the end user to access a complete installed application while identifying the origin of objects in individual components. During translation verification testing of an application, each identified object is displayed with the associated tag identifying the origin of the identified object(s) so that the tester(s) view the translatable objects and identify defects in the components of the installed application. The tags associated with the translatable objects allow the tester(s) to correctly identify the origin of the translatable object and to efficiently correct the defect in the translation of the identified object. In addition, the tags provide tester(s) with the information needed to accurately log defects to the correct component. Based upon the log, a defect triage team can appropriately assign the defect to a specific person to rectify the defect.

The above described process outlines how to identify non-compiled and image resource files and how to apply tags to specific translatable objects and/or images based upon a set of prescribed rules. There are two general categories of tags, generic and specific. A generic tag may be applied to multiple translatable object categories. In one embodiment, a generic tag can be used for all translatable objects in a file or component. A specific tag has a one tag to one object ratio, i.e. there is a unique tag for each object. In one embodiment, a specific tag may take the form of a generic tag with a pre-attached or post-attached integer. Whether the tag is specific or generic, the tags may come in various formats. In one embodiment, the tags may be pre-attached or post-attached to the original translatable object. Similarly, tags can be added to or separated from an assigned translatable object using spaces, colons, hyphens, parenthesis, underscore, a symbol, or a combination of any of the above. Regardless of the tag format or category, each tag assigned to a resource file or image identifies the origin of the associated translatable object and/or image. Once the translatable objects and/or images have been modified, the associated application can be tested for translation verification under normal operating conditions. The test results will identify any translatable objects that are not properly translated, and the associated tag provides data indicating the origin of the translatable object.

The invention can take the form of a hardware embodiment, a software embodiment or an embodiment containing both hardware and software elements. In a preferred embodiment, the invention is implemented in software, which includes, but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, random access memory (RAM), read-only memory (ROM), a rigid magnetic disk and an optical disk. Current examples of optical disks include compact disk read only memory (CD-ROM), compact disk B read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

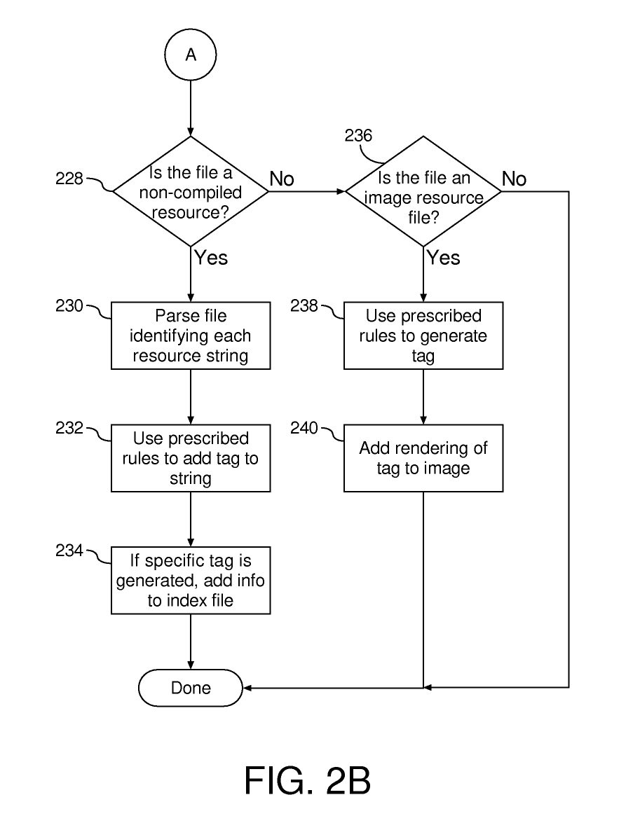

In one embodiment, the verification tool includes an assignment manager provided in software or hardware. The assignment manager is responsible for prescribing a set of rule to identify translatable objects and to assign tags to identified objects of a resource file. With respect to the software implementation, the assignment manager may include, but is not limited to, firmware, resident software, microcode, etc. The software implementation can take the form of a computer program product accessible from a computer-useable or computer-readable medium providing program code for use by or in connection with a computer or any instruction execution system. FIG. 3 is a block diagram (300) illustrating placement of the assignment manager in the system hardware. The illustration shows a computer system with a server (302) in communication with a client (304) across a network (310) through network adapters (312) and (314), respectively. Both the server (302) and the client (304) each include memory (322) and (324), respectively, and a processor (332) and (334), respectively. The processors support communication with storage media (350). The client (304) includes a manager (344) embedded therein. As noted above, in one embodiment the assignment manager may be in system software in which case the assignment manager (344) may be embedded within memory (324). The application to be verified is installed on either storage media (350) on the network (310) in communication with the server (302) and the client (304), or on memory (324) local to the client (304). Similarly, the server (302) includes a manager (342) embedded therein. The manager (342) may be in system software or hardware. In the case of embedding the manager in system software, the manager (342) is resident on the server memory (322). Similarly, the verification tool may be in the form of hardware and/or software. In one embodiment, the verification tool (344) resides local to the server (302) and may be accessed by the client (304) Similarly, in one embodiment, the manager (342) may be the verification tool manager to direct execution of instructions to determine the source of translatable objects in an installed application.

In one embodiment, the invention is implemented in software, which includes but is not limited to firmware, resident software, microcode, etc. The invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

Embodiments within the scope of the present invention also include articles of manufacture comprising program storage means having encoded therein program code. Such program storage means can be any available media which can be accessed by a general purpose or special purpose computer. By way of example, and not limitation, such program storage means can include RAM, ROM, EEPROM, CD-ROM, or other optical disk storage, magnetic disk storage or other magnetic storage devices, or any other medium which can be used to store the desired program code means and which can be accessed by a general purpose or special purpose computer. Combinations of the above should also be included in the scope of the program storage means.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, random access memory (RAM), read-only memory (ROM), a rigid magnetic disk, and an optical disk. Current examples of optical disks include compact disk B read only (CD-ROM), compact disk B read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled with the system to enable the data processing system to become coupled with other data processing systems or remote printers or storage devices through intervening private or public networks. Modems, wireless and Ethernet adapters are just a few of the currently available types of network adapters.

### Advantages Over the Prior Art

The translation verification tool efficiently identifies the source of a translatable object in an application. Rules may be invoked to identify specific categories of translatable objects in an application and to attach tags to the objects. The tags are associated with the source of the translatable objects. During verification testing of the application, the source of a translatable object that is shown to contain an error would be identifiable through the attached tag without affecting the integrity or execution of the application.

### Alternative Embodiments

It will be appreciated that, although specific embodiments of the invention have been described herein for purposes of illustration, various modifications may be made without departing from the spirit and scope of the invention. In particular, for applications with multiple components working together the verification process can be complex. Tags can be attached to all translatable objects, i.e. any item that needs to be translated, except for the objects in the components to be tested. This provides an indicator to the tester that all tagged translatable objects can be ignored and testing of the application only needs to process untagged objects. In another form, the user of the verification tool can tag all components in an application and use this version of the application as a reference when testing the application on an alternate machine. Similarly, beyond testing for proper translation, the tool may be invoked to test translation context, such as for font size and display. Accordingly, the scope of protection of this invention is limited only by the following claims and their equivalents.

We claim:

1. A method for identifying a resource origin within an application, comprising:
running a tag tool on an install directory of a component of an installed application;
modifying a resource file of said component of said installed application by adding a tag to each translatable object, wherein said tag is descriptive of a source component; and
identifying an origin of the translatable object based upon said tag.

2. The method of claim 1, wherein said tag provides information to identify a component containing an associated translatable object.

3. The method of claim 1, wherein said tag is attached to an original translatable object.

4. The method of claim 1, further comprising limiting tests to untagged translatable objects by adding tags to all translatable objects except for translatable objects in a component to be tested.

5. The method of claim 1, further comprising tagging all translatable objects in an application and using a tagged version of said application as a reference.

6. The method of claim 1, wherein said translatable object is in the form selected from a group consisting of: a resource string and an image.

7. A computer system, comprising:
a tag tool in communication with an install directory of an installed application;
a tag tool manager in communication with the tag tool and the installed application, said installed application having a resource file modifiable by said tag tool manager with addition of a tag to each translatable object, wherein said tag is descriptive of a source component; and
said tag identifies an origin of the translatable object based upon a characteristic of said tag.

8. The system of claim 7, wherein said tag provides information to identify a component containing an associated translatable object.

9. The system of claim 7, wherein said tag is attached to an original translatable object.

10. The system of claim 7, further comprising a test limitation to identify untagged translatable objects by addition of tags to all translatable objects except for translatable objects in a component to be tested.

11. The system of claim 7, further comprising said manager execute instructions to tag all translatable objects in said application through use of a tagged version of said application as a reference.

12. The system of claim 7, wherein said translatable object is in the form selected from a group consisting of: a resource string and an image.

13. A computer program product comprising
a computer-readable medium having computer useable program code for identifying a resource origin within an application, wherein the computer readable program when executed on a computer causes the computer to:
run a tag tool on a portion of an install directory of an installed application;
modify a resource file of said installed application by adding a tag to each translatable object, wherein said tag is descriptive of a source component; and
identify an origin of the translatable object based upon said tag.

14. The computer program product of claim 13, wherein the medium is a recordable data storage medium.

15. The computer program product of claim 13, wherein said tag provides information to identify a component containing an associated translatable object.

16. The computer program product of claim 13, wherein said tag is attached to an original translatable object.

17. The computer program product of claim 13, further comprising instructions to limit tests to untagged translatable objects by adding tags to all translatable objects except for translatable objects in a component to be tested.

18. The computer program product of claim 13, further comprising instructions to tag all translatable objects in an application and use a tagged version of said application as a reference.

19. The computer program product of claim 13 wherein said translatable object is in the form selected from a group consisting of: a resource string and an image.

20. A method for identifying a resource origin within an application, comprising:
running a verification tool on an install directory of a component of an installed application;
modifying a resource file of said component of said installed application by adding a string identifier to each translatable object, wherein said string identifier is descriptive of a source component; and
identifying an origin of the translatable object based upon said string identifier, wherein said string identifier is displayed with said translatable object upon execution of said installed application
